(19) United States
(12) Patent Application Publication
(10) Pub. No.: US 2012/0023108 A1
(43) Pub. Date: Jan. 26, 2012

(54) SYSTEM TO DETERMINE PEER RANKING OF INDIVIDUAL IN A SOCIAL NETWORK

(75) Inventors: Scott W. Slinker, San Jose, CA (US); Anthony A. Shah-Nazaroff, Santa Clara, CA (US); James T. Brady, San Jose, CA (US)

(73) Assignee: Jake Knows, Inc., San Jose, CA (US)

(21) Appl. No.: 13/094,590

(22) Filed: Apr. 26, 2011

Related U.S. Application Data
(60) Provisional application No. 61/328,598, filed on Apr. 27, 2010.

(51) Int. Cl. G06F 17/30

(52) U.S. Cl. 707/748; 707/E17.014

(57) ABSTRACT

A system comprising a database containing information concerning uniquely identified entities. The database further contains a list of attributes describing the products, skills, or services provide by the entities. A server compares the desired referral of a first entity to one or more second entities having the desired product, skill, or service, and by evaluating the relationship between the first entity and second entities, presents those second entities in the order of their value as a referral.

### RELATED APPLICATIONS

The present application claims the benefit under 35 U.S.C. 119(e) of U.S. Provisional Patent Application Ser. No. 61/328,598, filed Apr. 27, 2010, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, Jake Knows, Inc, All Rights Reserved.

### TECHNICAL FIELD

Example embodiments relate to discovering and determining rankings of individuals and entities having relationships with one or more people or entity, based on a database that links the individual, or to one or more individuals or entities, based on indicia contained in the database.

### BACKGROUND

In one's business and entity life, there is a need to identify a level of trust in others in order to determine the risks associated with having business, personal or other relations ships with them.

### BRIEF DESCRIPTION OF THE DRAWINGS

FIG. 1 is a representation of an environment, according to an example embodiment.

FIG. 2 is a drawing of a cell phone client architecture, according to an example embodiment.

FIG. 3 is a drawing of an Internet appliance architecture, according to an example embodiment.

FIG. 4 is a drawing of the server architecture, according to an example embodiment.

FIG. 5 is a representation of the entity table entry, according to an example embodiment.

FIG. 6 is a representation of a contact list entry, according to an example embodiment.

FIG. 7 is a representation of a trust assessment query, according to an example embodiment.

FIG. 8 is a representation of the communications log, according to an example embodiment.

FIG. 9 is a representation of an attribute descriptor, according to an example embodiment.

FIG. 10 is a diagram of a representative trust data structure, according to an example embodiment.

FIG. 11 is a flow diagram of the trust assessment process, according to an example embodiment.

FIG. 12 is a block diagram of machine in the example form of a computer system within which a set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the embodiments present invention may be practiced without these specific details.

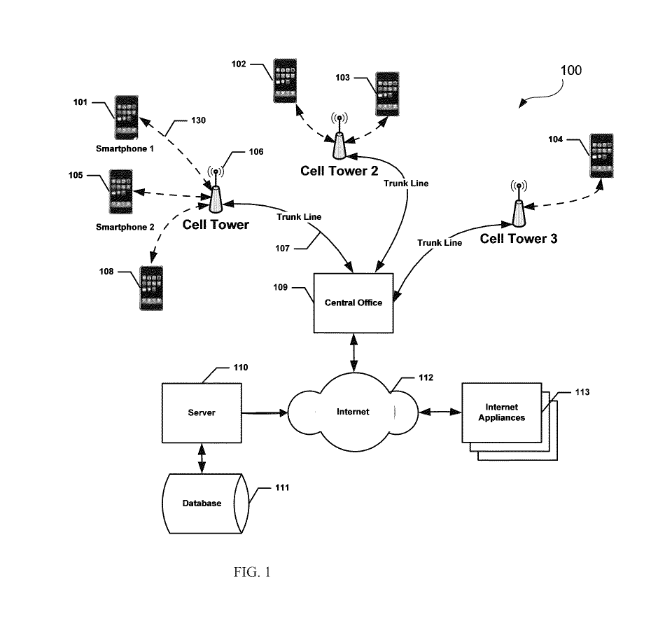

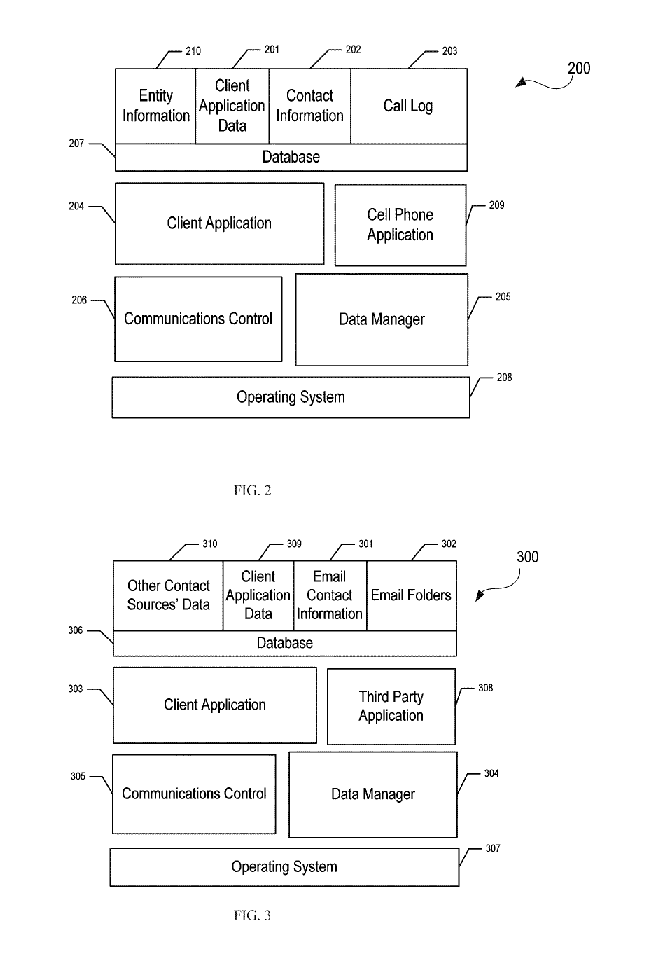

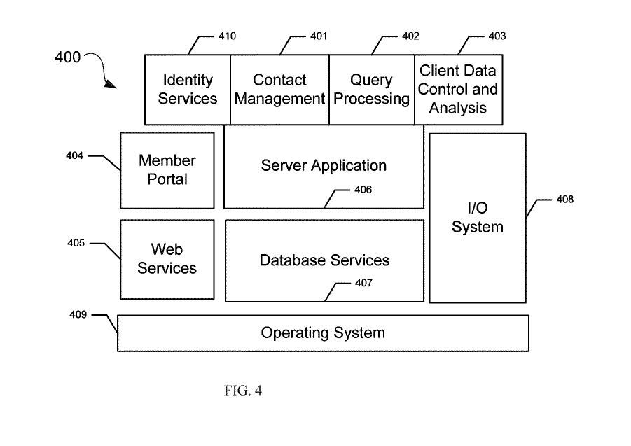

FIG. 1 is a block diagram illustrating an environment in which various example embodiments may be deployed. Elements 101 through 108 are smart phones and feature phones (collectively referred to as phones) which are connected through various wireless networks that are currently in place to support communications with the devices. In an example embodiment, the phone 101 connects, via the most accessible cell tower 106, to a central office 109, via a trunk line 107, using standard technology. Additionally, one or more Internet appliances 113 are connected through the Internet 112. Each phone 101-108 may have a software structure similar to a cell phone client architecture 200 described below. (See FIG. 2). As shown in FIG. 2, a phone may host a client application 204 that collects information about an entity using the phone 101, and transmits the information through links (e.g., through a cell phone radio transmission link 130, one or more trunk lines 107, and the Internet 112) to an application server 110 (also referred to as an referral server) connected to a database 111. The referral server 110 has a server architecture 400 described below. (See FIG. 4). As shown in FIG. 4, the referral server 110 includes a server application 406 that receives the information and adds it to the database 111. After the information is added to the database 111, it is processed by a server application (see 406 of FIG. 4) by executing the processes describe herein.

FIG. 2 is a block diagram depicting the cell phone client architecture 200, according to an example embodiment. The cell phone client architecture 200 includes entity information 210, client application data 201, contact information 202, a call log 203, a client application 204, a data manager 205, a communications control 206, a database 207, an operating system 208, and a cell phone application 209.

The operating system 208 provides base hardware control mechanism to applications, tasks, and services running on the phone 101. In example embodiments, the operating system 208 is provided by the manufacturer of the phone (e.g., 101, see FIG. 1) or, in other example embodiments, by a third party. The services communications control 206, the database 207, and the data manager 205 are built on the services of the operating system 208. The communications control 206 is an interface from the client application to the communications network. In the case of the cell phone based systems, the communications network may be the common carriers network, represented by trunk line 107 and central office 109, linked to the Internet 112. For the Internet appliances 113, the communications network may be the Internet 112. The communications control 206 interfaces with the client application 204 and acts as the port for the client application's 204 communications with the referral server 110. The data manager 205 controls the physical storage in the client and controls access, security, space management for various modules of the phone 101, such as the client application 204, the cell phone application 209, and the database 207. The client application 204 provides an interface to the various services provided by the reeferral server 110. The cell phone application 209 is provided by the cell phone vendor to provide cell phone services to a user. The database 207 stores, retrieves, and manages information in the various databases, including, for example, the entity information 210, the client application data 201, the contact information 202 and the call log 203, and provides the query and update services for these data. The entity information 210 includes information describing a user. The entity information 210 may be extended by the client application 204 to further include information appropriate to support the referral server 110 applications. The client application data 201 contains data structures that support the client application 204. The contact information 202 supports cell phone or web application contact list features. The contact information 202 is, in some example embodiments, augmented by the client application 204 to support the referral server 110 applications. The call log 203 is provided by the cell phone or web application. The call log 203 includes information about the user's contacts. The call log 203 may be accessed by the client application 204 to support the functions taught herein.

FIG. 3 is a block diagram depicting in Internet appliance client architecture 300, according to an example embodiment. The Internet appliance client architecture 300 includes other contact sources' data 310, client application data 309, email contact information 301, email folders 302, a database 306, a client application 303, a third party application 308, a communications control 305, a data manager 304, and an operating system 307.

The operating system 307 provides base hardware control mechanism to the modules of the Internet appliance client architecture 300. The operating system 307 may be provided by a manufacturer of the client system or a third party. The communications control 305, database 306, and data manager 304 are built on the services of the operating system 307.

The communications control 305 is an interface from the client application 303 to a communications network. As described earlier, in the case of the cell phone based systems, the communications network may be the common carriers network, represented by trunk line 107 and central office 109, linked to the Internet 112. For the Internet appliances 113, the communications network is the Internet 112. The communications control 305 is interfaced with client application 303 and acts as a port for the client application's 303 communications with the referral server 110.

The data manager 304 controls the physical storage in the client by controlling access, security, and space management for the client application 303, third party applications 308 and database 306. The client application 303 provides an interface to the various services provided by the referral server 110. The third party applications 308 are provided by a number of sources (e.g., third party developers) and share the Internet appliances 113 with the client application 303. The database 306 manages the information in the various databases of other contact sources' data 310, client application data 309, email contact information 301 and the email folders 302, and provides various database services, such as query and update services for these data 310, 309, 301, and 302. Other contact sources' data 310 includes information about the user contact such as photograph, likes, dislikes, activities participated in, and other user information. The client application data 309 includes the new data structures to support the client application 303.

Email contact information 301 is used by email programs for the entity's contacts. It is augmented by the client application 303 to support the applications hosted on the referral server 110. Email folders 302 contain the email that has been received and sent by the user. The email folders 302 are the analog of the call log 203 of cell phone client architecture 200. (See FIG. 2). The email folders 302 are accessed by the client application 303 to support the function taught herein.

FIG. 4 is a block diagram depicting a server architecture 400 for the referral server 110, according to an example embodiment. The server architecture 400 includes a conventional operating system 409 like IBM'S Z/OS, LINUX, UNIX, and MICROSOFT WINDOWS 7 other operating systems. From an architectural standpoint, an input/output (I/O) system 408 operates on top of the operating system 409 to provide services to manage I/O devices (e.g., disk storage and communications hardware). The other components of the system may interface with the I/O system 408 to perform these services. Database services 407 provide a repository for data structures of the server application 406. These data structures may be stored in a variety of forms, such as flat files, relational, hierarchical, and object databases. The web services 405 provide the protocols and controls to connect to the Internet 112. The web services 405 are used by the server application 406 to communicate with the various client machines. The member portal 404 receives requests for referrals from the clients via the web service 405 and passes them to the server application 406, which executes the various processes described herein. The server application 406 can be further subdivided into sub-functions including, in an example embodiment: identity services 410 (e.g., registration, login, and verification), contact management 401 (e.g., discovery, validation, and association analysis), query processing 402, and client data control and analysis 403. The structure and arrangement of the components of server architecture 400 is one of a number of implementations that one skilled in the state-of-the-art could design.

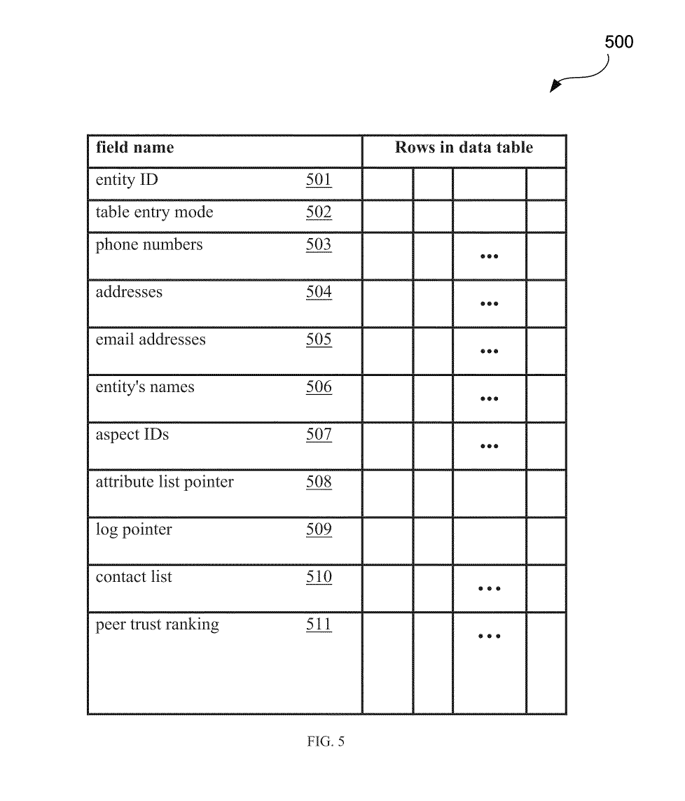

FIG. 5 is table showing content of an entity table 500, according to an example embodiment. The entity table 500 describes an entity or an aspect of either a member or a contact of the member. The entities can be people, companies, businesses, organizations, or other entity. The entries of the entity table 500 may be stored in a conventional database and can be accessed based on one or more of the fields 501-511. The fields 501-511 in this structure were picked as representative and should not be construed to limit what is taught herein.

Entity identifier (ID) 501 is a unique ID for an entity table 500 entry. Table entry mode 502 indicates if this is the root entry for the entity, and contains one entity ID 501 that identifies the entity. The entity table 500 further includes fields that describe contact information of the entity, such as one or more fields representing the entity's phone numbers 503, addresses 504, email addresses 505, and names 506.

The entity table 500 may further include a field 507 that stores aspect IDs. The aspect ID field 507 may include a list of the ways this entity has elected to be known; attribute list pointer 508 specifies a list of attribute names which apply to this entity; a log pointer 509 is a used to locate log entries; a contact list 510 contains a list of entity IDs for all the contacts of the entity; and a peer trust ranking 511 contains the trust ranking

Aspects such as “carpenter”, “machinist”, etc. indicate skills with which entities and their attributes describe the services that they offer. For a carpenter, the services may include: “furniture”, “framing”, and “restoration” among others. Aspects such as “retailer', “service station owner”, etc, may have attributes indicating the kinds of products they offer. For a retailer the products may be quite diverse. For example, a retailer may be in the furniture business, in which case the attributes for the retailer might include: “furniture”, “recliners”, “bedroom sets”, etc. The structure of the aspect allows the rich description of the skills, products, and services that one might need a referral to. The fields in entity table 500 were picked as representative and should not be construed to limit what is taught herein.

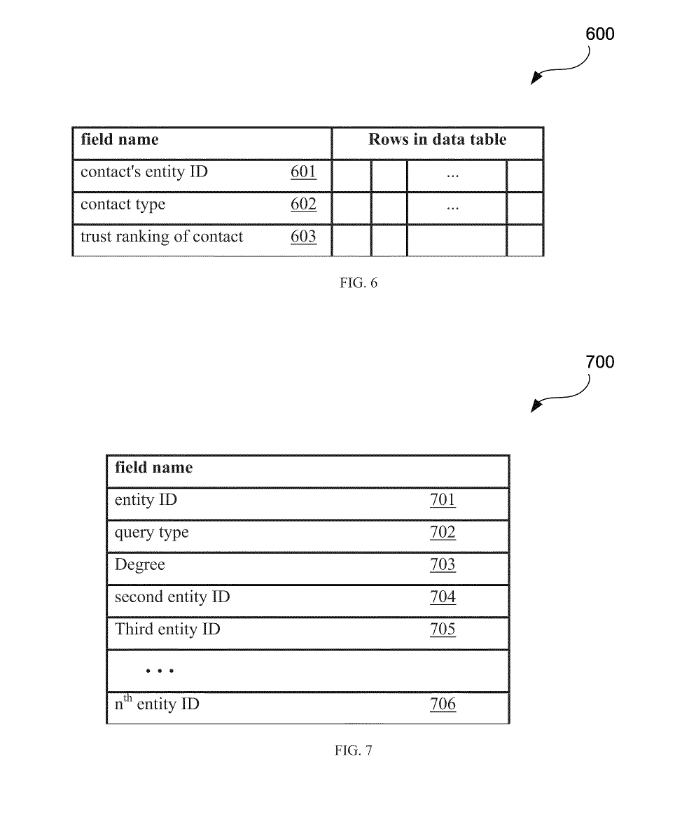

FIG. 6 is a table showing content of a contact list table 600, according to an example embodiment. As shown, the contact list table 600 includes:
a contact's entity ID 601, which is the unique identifier of the entity stored in the entity table 500 (see FIG. 5), and has a entity ID 501 that corresponds (e.g., is identical) to a contact's entity ID 601;
a contact type 602 indicates whether the corresponding contact is a direct or implied contact; and
a trust ranking of contact 603 that indicates how well the entities' contacts and contacts' contacts down to the degree specified trust the entity whose entity table entry points to the contact list table 600.

FIG. 7 is a block diagram showing a trust assessment query 700, according to an example embodiment. The trust assessment query 700 contains:
the entity ID 701 indicating the entity requesting the query;
a query type 702; and
a degree 703 which specifies the number of contact links allowed between the requester of a referral and the reference selected by the query.

In an example embodiment, the trust assessment query 700 may further specify one or more additional entities (704-706) to perform the query. As a result of including more than one entity to perform a search, the server will rank the entities based on their corresponding trust values, as will be described below.

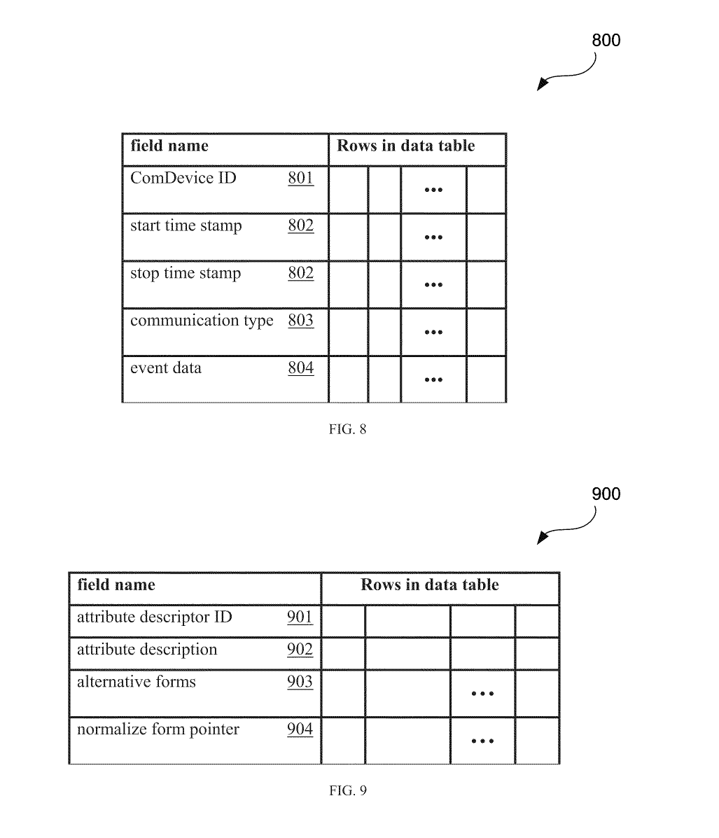

FIG. 8 is a table showing content of a communications log 800, according to an example embodiment. The communications log 800 describes the phone calls and other communications made and received by an entity ID 501 (see FIG. 5) from any of the communications devices (such as phones 101-108 of FIG. 1) for the entity. The fields contained in the communications log 800 may include, for example:
comDevice ID 801, a unique ID assigned to the phone or Internet appliance;
start timestamp 802, which contains the date and time the communication started;
stop timestamp 803, which contains the date and time the communication stopped;
communication type 804, which indicates the type of call, e.g., call out, call in, call missed, voicemail received, text, email, Facebook posting, etc; and
event data 805, which contains any text, image, or other digital information associated with the communication.

FIG. 9 is a table showing attribute descriptor data 900, according to an example embodiment. The attribute descriptor data 900 may, in some example embodiments, be composed of an attribute descriptor identifier (ID) 901, which is a fixed value that identifies the data structure as an attribute descriptor. The attribute descriptor data 900 also includes:
attribute description 902, which is a normalized description of the attributes in the attribute descriptor data 900, and a list of alternative forms 903 of the attribute description 902.
The alternative forms 903 is a list of attribute descriptor IDs that are synonyms for the attribute (e.g., “Dr.” is an alternative to “MD” but not vice versa).
Normalized form pointer 904 points to the attribute descriptor ID that has the appropriate attribute description. The attribute description is used when adding attributes to the database. For example, when adding the attribute “Baseball Referee” a entity's profile, the system would substitute “Baseball Umpire”.

This list is created and updated in the process of adding entities and contacts to the system, and while updating the various entities and contacts information. Attribute descriptors are maintained in a separate table in the database and can be queried by various query languages including SQL. The attribute descriptors IDs are stored in a database table with one entry for each unique attribute. The fields in this structure were picked as representative and should not be construed to limit what is taught herein.

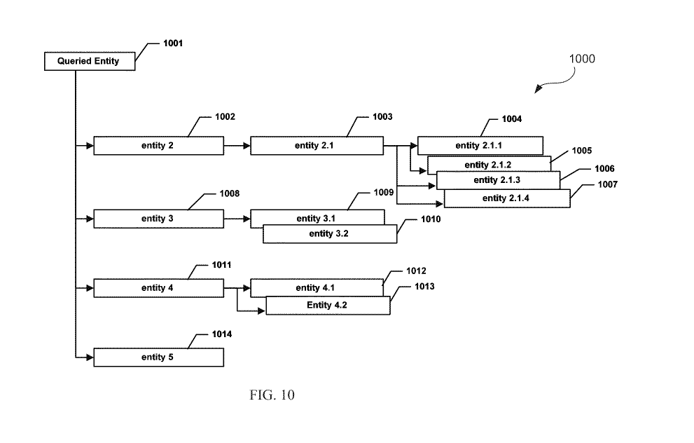

FIG. 10 is a diagrammatic representation of an example trust data structure 1000, according to an example embodiment. The trust data structure 1000 describes the contact list 510 (of FIG. 5) viewed across two or more levels (also referred to as degrees). FIG. 10 shows the trust data structure 1000 in the form of a tree. Each entity entry (1002-1014) describes an entity that is a member of the system or is a contact of a member. The entity table 500 entry of each layer is used to get the next layer of contacts, until the tree reaches the specified degree. The trust data structure 1000 is not a separate entity but exists as a result of the IDs and pointers in the entity table 500 and the associated contact list entry 600 (of FIG. 6).

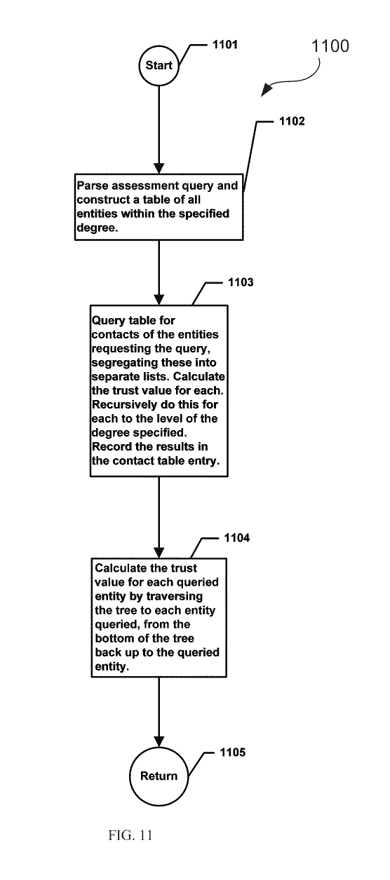

FIG. 11 is a flow diagram of a method 1100 of assessing trust, according to an example embodiment. The method describes how a trust data structure is constructed and then evaluated. Operation 1101 parses the query using various techniques known to one skilled in the art. Step 1102 takes the contact lists of the entity and accesses the next level in the trust data structure 1000 (of FIG. 10), and then recursively progresses through the entity table entries and contact lists 510 with its associated contact list entries 600. Once the trust data structure 1000 is constructed using, for example, backtracking methods, the trust data structure 1000 is traversed collecting the trust assessment of each level, combining and merging them until the root of the tree is reached, giving the peer trust ranking 511. The back tracking of the trust data structure 1000 provides an indication of the trustworthiness of a selected entity by determining whether other trustworthy entities trust the selected entities. That is to say, an entity is more likely to be trustworthy if trustworthy entities trust that entity. Thus, one entity may inherit some portion of the trustworthiness of its contact list. In some example embodiment, the trust ranking may be based on experience data, such as experience with an entity based on that entity's aspect (e.g., carpenter). An entity's experience with another entity may be fed back into the system 100 to affect other trust values.

Example embodiments may utilize a variety of other metrics to determine the peer ranking 511. For example, one example embodiment may calculate the ranking based on the trust ranking of the contact 603 (see FIG. 6). In other example embodiments, the peer ranking 511 may be calculated based on the communications log 800 (see FIG. 8). For example, trust may be inferred if two entities exchange communications beyond a determinable threshold. Conversely, a lack of trust may be inferred if two entities have communicated with each other only a few times. The threshold may vary depending on the relationship between the entity and the contact. For example, one would assume that some aspects would involve greater communication than others. For example, the threshold number of calls to and from a real estate agent may differ from the threshold number of calls to and from a carpenter.

### Modules, Components and Logic

Certain embodiments described herein as include logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures should be given consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

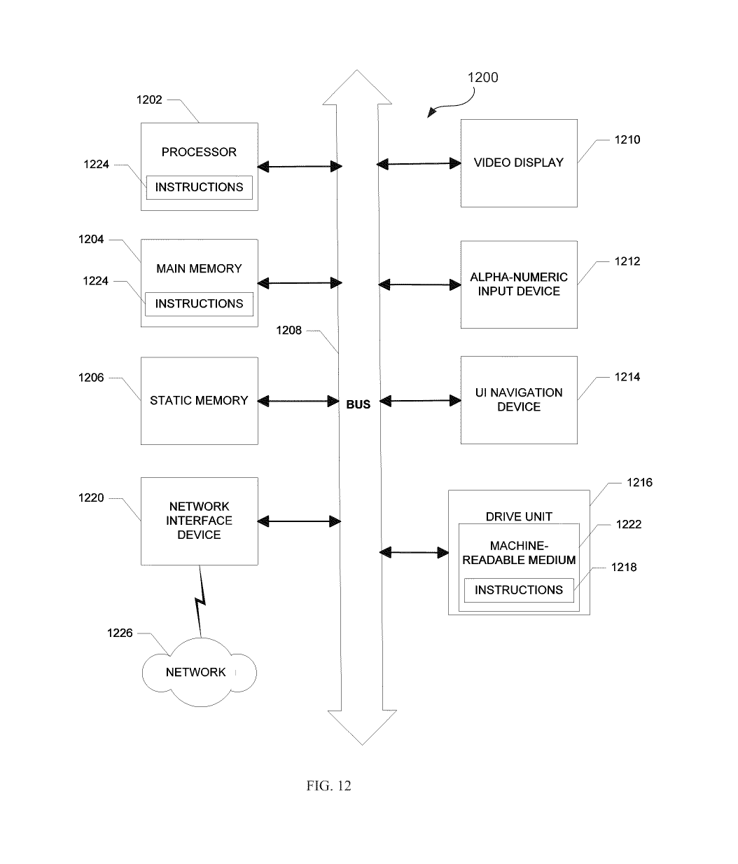

FIG. 12 is a block diagram of machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a entity computer (PC), a tablet PC, a set-top box (STB), a entity Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device (e.g., a speaker) and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent to those of skill in the art upon reviewing the above description.

What is claimed is:

1. A system comprising:
a database configured to store information describing an entity, the information including one or more contacts of the entity and an assessment of trustworthiness corresponding to each contact, the one or more contacts also including one or more further contacts; and
a server connected to the database, the server being configured to:
receive a request to determine a peer trust ranking,
access the information, and
responsive to the request, construct a trust data structure that links the entity to the one or more contacts and the one or more further contacts,
wherein the server calculates a peer trust ranking of the entity based on the trust data structure.

2. The system of claim 1, wherein the peer trust ranking is further based on a degree of relationship between the entity and the one or more contacts, and between the entity and the one or more further contacts.

3. The system of claim 1, wherein the peer trust ranking is further based on a trust ranking corresponding to each of the one or more contacts.

4. The system of claim 1, wherein the peer trust ranking is further based on a first call log corresponding to the entity and a second call log of the one or more contacts.

5. A method comprising:
receiving, from an entity, a request to determine a peer trust ranking;
based on the request, identifying one or more contacts of the entity and an assessment of trustworthiness corresponding to each contact, the one or more contacts also including one or more further contacts;
generating a trust data structure, the trust data structure linking the entity to the one or more contacts and the one or more further contacts; and
calculating the peer trust ranking based on the trust data structure.

6. The method of claim 5, wherein the calculation of the peer trust ranking comprises identifying a degree of relationship between the entity and the one or more contacts, and between the entity and the one or more further contacts.

7. The method of claim 5, wherein the calculation of the peer trust ranking comprises identifying a trust ranking corresponding to each of the one or more contacts.

8. The method of claim 5, wherein the calculation of the peer trust ranking comprises identifying communications exchanged between the entity and the one or more contacts.

9. The method of claim 5, wherein the calculation of the peer trust ranking comprises determining whether communications exchanged between the entity and the one or more contacts has exceeded a threshold value.

10. The method of claim 5, wherein the calculation of the peer trust ranking comprises identifying the entity's trust rankings given by trustworthy entities.

11. The method of claim 10, the identification of the trust rankings given by trustworthy entities comprises:
recursively generating a trust data structure for each contact of the one or more contacts; and
based on the trust data structures generated, calculating peer trust rankings for each contact of the one or more contacts.

12. The method of claim 5, wherein the calculation of the peer trust ranking comprises identifying experience data, the experience data describing an aspect of the entity or the one or more contacts.

13. A non-transitory computer-readable storage medium having embedded therein a set of instructions which, when executed by one or more processors of a computer, causes the computer to execute the following operations:
receiving, from an entity, a request to determine a peer trust ranking;
based on the request, identifying one or more contacts of the entity and an assessment of trustworthiness corresponding to each contact, the one or more contacts also including one or more further contacts;
generating a trust data structure, the trust data structure linking the entity to the one or more contacts and the one or more further contacts; and
calculating the peer trust ranking based on the trust data structure.

14. The computer-readable storage medium of claim 13, wherein the calculation of the peer trust ranking comprises identifying a degree of relationship between the entity and the one or more contacts, and between the entity and the one or more further contacts.

15. The computer-readable storage medium of claim 13 wherein the calculation of the peer trust ranking comprises identifying communications exchanged between the entity and the one or more contacts.

16. The computer-readable storage medium of claim 13 wherein the calculation of the peer trust ranking comprises identifying communications exchanged between the entity and the one or more contacts.

17. The computer-readable storage medium of claim 13 wherein the identification of the trust rankings given by trustworthy entities comprises:
recursively generating a trust data structure for each contact of the one or more contacts; and
based on the trust data structures generated, calculating peer trust rankings for each contact of the one or more contacts.
